(19) United States
(12) Patent Application Publication
(10) Pub. No.: US 2025/0108856 A1
(43) Pub. Date: Apr. 3, 2025

(54) STEERING DEVICE

(71) Applicant: TOYODA GOSEI CO., LTD., Kiyosu-shi (JP)

(72) Inventors: Arata NAKAYAMA, Kiyosu-shi (JP); Shintaro NAKAMURA, Kiyosu-shi (JP); Masaaki IEDA, Kiyosu-shi (JP); Junichi IEDA, Kiyosu-shi (JP); Yuichi TSUNEKAWA, Kiyosu-shi (JP); Tatsuhide HOTTA, Kiyosu-shi (JP)

(21) Appl. No.: 18/814,677

(22) Filed: Aug. 26, 2024

(30) Foreign Application Priority Data
Sep. 28, 2023 (JP) 2023-167567

(51) Int. Cl. B62D 1/06; B32B 1/00; B32B 3/04; B32B 7/025; B32B 15/04; B32B 27/36; B62D 1/04; G01V 3/08

(52) U.S. Cl. CPC B62D 1/065; B32B 1/00; B32B 3/04; B32B 7/025; B32B 15/04; B32B 27/36; B62D 1/046; G01V 3/088; B32B 2307/202; B32B 2307/206; B32B 2307/546; B32B 2605/003

(57) ABSTRACT

The steering device includes a rotation part, and a gripping part for being gripped by an occupant; the gripping part includes a core metal part, and a covering part covering the core metal part and including a first layer, a second layer, and a third layer; the first layer is positioned closer to the core metal part, compared to the second and third layers, and has conductivity; the second layer is arranged between the first and third layers, and is formed of a flexible non-conductive material; the third layer is exposed to outside, and is formed of a non-conductive material; and the steering device further includes a detector for detecting a change in capacitance generated between the occupant gripping the gripping part and the first layer, and a control unit for determining gripping condition of the gripping part based on the change in capacitance detected by the detector.

### CROSS REFERENCE TO RELATED APPLICATIONS

The present application claims the priority based on Japanese Patent Application No. 2023-167567 filed on Sep. 28, 2023, the disclosure of which is hereby incorporated by reference in its entirety.

### BACKGROUND

### Field

The present disclosure relates to a steering device.

### Related Art

Japanese Patent Laid-Open Publication No. 2019-992 discloses a steering wheel including an outer cover member which covers a core metal covering part and contains a conductive material. The core metal covering part covers a core metal. The outer cover member includes a substrate layer attached to the core metal covering part, an elastic body layer laminated on the substrate layer, and a coat layer applied on the elastic body layer. The elastic body layer is formed of a flexible elastomer material, a rubber material, polyvinyl chloride, or the like. The coat layer is made by applying a coating material containing a urethane resin, an acrylic resin, a silicone resin, a fluororesin, or the like. The elastic body layer and the coat layer contain a conductive material. According to JP2019-992A, a gripping condition of a steering wheel by a driver is detected on the basis of a change in capacitance detected by a capacitance sensor configured to detect capacitance between the elastic body layer and the core metal respectively serving as electrodes. In the steering wheel according to JP2019-992A, the elastic body layer ensures flexibility of the outer cover member. Moreover, in the steering wheel according to JP2019-992A, since the coat layer contains a conductive material, the conductive material is positioned close to driver's hand, and accordingly the coat layer along with the elastic body layer containing a conductive material are able to detect the gripping condition.

In JP2019-992A, the elastic body layer is subjected to plating, and accordingly the elastic body layer is considered to contain a conductive material. It is generally known that an elastic body layer subjected to plating has lower flexibility, compared to an embodiment of an elastic body layer not subjected to plating. It is also generally known that since a coating film on a steering wheel is exposed to air, the coating film is likely to deteriorate. Accordingly, it is desired to provide a steering device which is configured to ensure flexibility and detect the gripping condition without being affected by deterioration of the coating film.

### SUMMARY

In one aspect of the present disclosure, a steering device is provided. The steering device is mounted on a movable body, and includes a rotation part attached to the movable body so as to be rotatable, and a gripping part connected to the rotation part and configured to be gripped by an occupant; the gripping part includes a core metal part positioned on both sides of the rotation part, and a covering part configured to cover the core metal part and including a first layer, a second layer, and a third layer; the first layer is positioned closer to the core metal part, compared to the second layer and the third layer, and has conductivity; the second layer is arranged between the first layer and the third layer, and is formed of a non-conductive material having flexibility; the third layer of the gripping part is exposed to outside, and is formed of a non-conductive material; and the steering device further includes a detector configured to detect a change in capacitance generated between the occupant gripping the gripping part and the first layer, and a control unit configured to determine gripping condition of the gripping part based on the change in capacitance detected by the detector.

### BRIEF DESCRIPTION OF THE DRAWINGS

FIG. 1 is a schematic diagram illustrating the steering device in the present embodiment.

FIG. 2 shows a cross-sectional view of the steering device shown in FIG. 1 along a line II-II.

FIG. 3 is a block diagram illustrating the configuration of a control unit.

FIG. 4 shows a cross-sectional view of a gripping part in a second embodiment.

### DETAILED DESCRIPTION

### A. First Embodiment

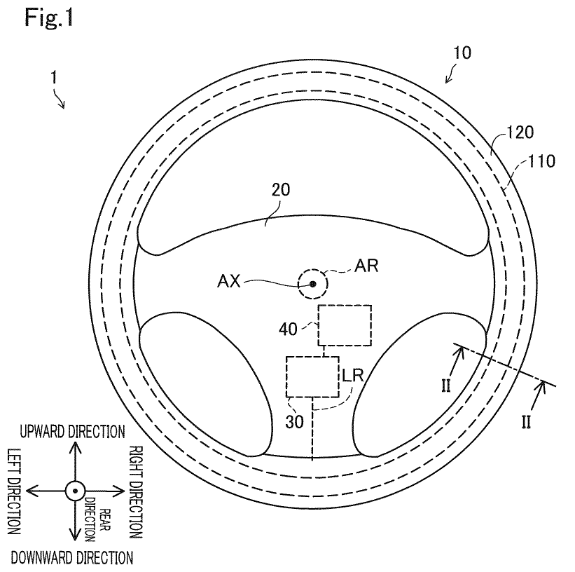

FIG. 1 is a schematic diagram illustrating a steering device 1 in the present embodiment. The steering device 1 is mounted on a movable body. In the present embodiment, the steering device 1 is mounted on a vehicle. The steering device 1 is operated by a driver who is an occupant of the vehicle. The steering device 1 is connected to a rotation shaft AR of the vehicle, and configured to be rotatable around an axis line AX of the rotation shaft AR. The rotation of the steering device 1 is transmitted to a steering gearbox not illustrated, via the rotation shaft AR. The direction along the axis line AX of the rotation shaft AR is defined as the front-back direction for convenience. The direction of raising the steering device 1, out of the directions orthogonal to the axis line AX, is defined as an up-down direction. The upward direction is the direction of 12 o'clock centered on the axis of rotation AR. The downward direction is the 6 o'clock direction centered on the axis of rotation AR. The direction orthogonal to the axis line AX and the up-down direction is defined as a left-right direction. The right direction is the direction of 3 o'clock centered on the axis of rotation AR. The left direction is the direction of 9 o'clock centered on the axis of rotation AR. The steering device 1 includes a gripping part 10, a rotation part 20, a detector 30, and a control unit 40.

The gripping part 10 is the portion which is gripped by a driver. In the present embodiment, the gripping part 10 has a substantially ring-like shape when viewed in the front-back direction. The inner periphery of the gripping part 10 is connected to the rotation part 20. The gripping part 10 partially covers the rotation part 20. The gripping part 10 is thus connected to the rotation part 20. The gripping part 10 has a core metal part 110 and a covering part 120. In FIG. 1, the core metal part 110 is indicated with broken lines.

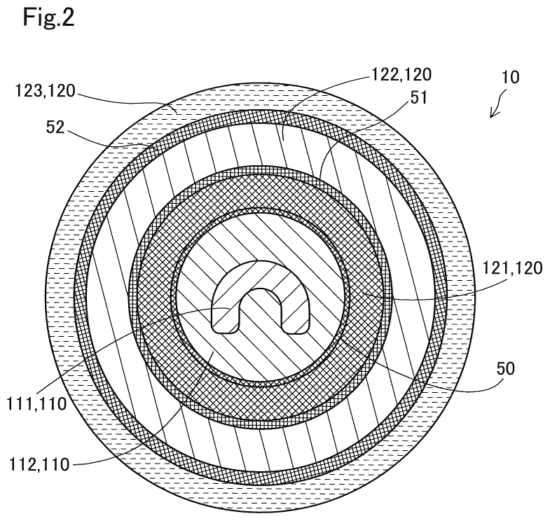

FIG. 2 shows the cross-sectional view of the steering device 1 shown in FIG. 1 along a line II-II. The core metal part 110 is configured as a skeletal part of the gripping part 10. As shown in FIG. 1, the core metal part 110, when viewed in the front-back direction, is positioned on both sides of the rotation part 20. As shown in FIG. 2, the core metal part 110 includes a core metal 111 and a core metal covering part 112. The core metal 111 has a ring-like shape when viewed in the front-back direction. The core metal 111 is formed of metal, and has conductivity. The core metal 111 is formed of, for example, iron, aluminum, magnesium, or an alloy containing one or more of these. The core metal 111 is grounded. The core metal covering part 112 covers the core metal 111. The core metal covering part 112 is formed of a material having insulating properties, other than metal. The core metal covering part 112 may be formed by in-mold molding by use of a soft material or an elastic material, for example, polyurethane foam. The core metal covering part 112 may be formed of a hard material.

The covering part 120 covers the core metal part 110. As shown in FIG. 2, the covering part 120 corresponds to the outermost layer of the gripping part 10, and is the portion which is gripped by a driver. The covering part 120 includes a first layer 121, a second layer 122, and a third layer 123. The first layer 121 functions as a capacitive sensor which detects capacitance generated between the gripping part 10 and the driver who grips the gripping part 10. The first layer 121 is electrically connected to the detector 30 via a lead wire LR shown in FIG. 1. The first layer 121 has conductivity. As shown in FIG. 2, the first layer 121 is positioned closer to the core metal part 110, compared to the second layer 122 and the third layer 123. In the present embodiment, the first layer 121 is attached to the core metal part 110 with a double-side tape 50. The first layer 121 is made by applying metal plating to a textile fabric. In the present embodiment, synthetic fiber formed of polyester is used as the textile fabric. Metal, for example, copper, nickel, tin, or silver, is selected as a conductive material.

The second layer 122 gives a soft feel to the driver who grips the gripping part 10. The second layer 122 is arranged between the first layer 121 and the third layer 123. In the present embodiment, the second layer 122 is laminated on the first layer 121 with a double-side tape 51. The second layer 122 is formed of a non-conductive material having flexibility. In the present embodiment, the second layer 122 is formed of PET (Polyethylene terephthalate). The third layer 123 protects the surface of the second layer 122. In the gripping part 10, the third layer 123 is exposed to the outside, and is the portion which is in contact with a driver. The third layer 123 is laminated on the second layer 122 with a double-side tape 52. The third layer 123 is formed of a non-conductive material. In the present embodiment, the third layer 123 is formed of a coating material containing silicone resin, acrylic resin, urethane resin, or the like.

The rotation part 20 shown in FIG. 1 is attached to a vehicle so as to be rotatable. The rotation part 20 is arranged so as to be surrounded by the gripping part 10. The rotation part 20 is shaped to have an internal cavity. In the internal cavity of the rotation part 20, there are the detector 30, the control unit 40, an airbag not illustrated, various types of circuits, and the like.

The detector 30 detects capacitance generated between the driver who grips the gripping part 10 and the first layer 121. The detector 30 detects changes in capacitance between the driver who grips the gripping part 10 and the first layer 121, on the basis of the detected capacitance values. The detector 30 includes various types of circuits such as an oscillation circuit, a resonance circuit, a detection circuit, and an amplification circuit, and detects changes in capacitance. Specifically, when the gripping part 10 is gripped by a driver, the capacitance between the first layer 121 functioning as a detection electrode and the driver then changes from the capacitance of the state in which the gripping part 10 is not gripped. In the detector 30, the resonant frequency which has changed as the capacitance has changed is subjected to amplitude modulation. The original signal is extracted from the signal subjected to the amplitude modulation, and is output as a voltage after amplification. The information about the voltage value is transmitted from the detector 30 to the control unit 40.

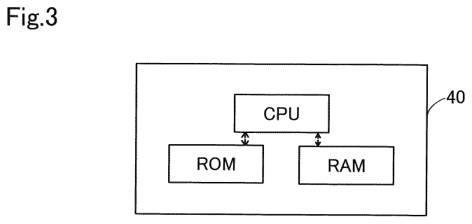

FIG. 3 is a block diagram illustrating the configuration of the control unit 40. As shown in FIG. 3, the control unit 40 is configured with a CPU serving as a processor, a RAM, and a ROM. An ECU (Electronic Control Unit) realizes various functions by executing previously installed programs. The control unit 40 controls the steering device 1, on the basis of the voltage value transmitted from the detector 30 and the instruction by the ECU of the vehicle not illustrated.

The control unit 40 determines the gripping condition of the gripping part 10 on the basis of the capacitance detected by the detector 30. The control unit 40 determines whether the gripping part 10 is gripped by a driver, on the basis of the capacitance detected by the detector 30. Specifically, the control unit 40 compares the voltage value of the detection result and a previously set threshold, and detects whether or not the gripping part 10 is gripped, on the basis of the comparison result.

The control unit 40 further executes airbag control and notification control to a driver. In the case where the driver releases the hand from the gripping part 10 while driving the vehicle, the control unit 40 notifies the driver of the releasing of the hand from the gripping part 10 with a buzzer sound or the like, via a speaker unit or a monitor not illustrated.

In the steering device 1 in the present embodiment, the first layer 121 has conductivity, thus allowing for detection of the gripping condition of the gripping part 10 on the basis of the change in capacitance of the first layer 121. The steering device 1 is configured to ensure the flexibility of the covering part 120 and detect the gripping condition without being affected by the deterioration of the third layer 123, compared to, for example, an embodiment in which a conductive material is contained in the second layer 122 formed of a material having flexibility, and the third layer 123 likely to be exposed to air because of the third layer 123 configured to be gripped by a driver who is an occupant.

The inventors of the present application have found that the fabric made by applying metal plating to a textile fabric has similar characteristics in elasticity to the second layer 122 and the third layer 123. The fabric made by applying metal plating to a textile fabric is used as the first layer 121, thereby suppressing the appearance defects caused due to the wrinkling generated by the deference in elasticity between the first layer 121 and the second layer 122, and the deterioration of the function of the first layer 121 as a capacitive sensor.

The steering device 1 in the present embodiment includes fewer components, compared to, for example, an embodiment including, in addition to the first layer 121, a capacitive sensor arranged between the covering part 120 and the core metal part 110. Accordingly, the steering device 1 requires fewer labor hours during manufacturing of the steering device 1, and also allows for the suppression of human errors in production and equipment defects. The steering device 1 including fewer components is less likely to experience a defect, compared to an embodiment including, in addition to the first layer 121, a capacitive sensor arranged between the covering part 120 and the core metal part 110.

When the first layer 121 having a conductive material is exposed to air, the accuracy of the detection of the first layer 121 serving as a detection electrode may be lowered due to the low dielectric constant of air. In the steering device 1 according to the present embodiment, the first layer 121 is attached to the core metal part 110 with the double-side tape 50. The second layer 122 is laminated on the first layer 121 with the double-side tape 51. This allows for the suppression of the exposure of the first layer 121 to air, compared to, for example, an embodiment in which the first layer 121 is sewn onto the core metal part 110, or an embodiment in which the second layer 122 is layered on the first layer 121, and accordingly allows for the suppression of the deterioration in accuracy.

### B. Second Embodiment

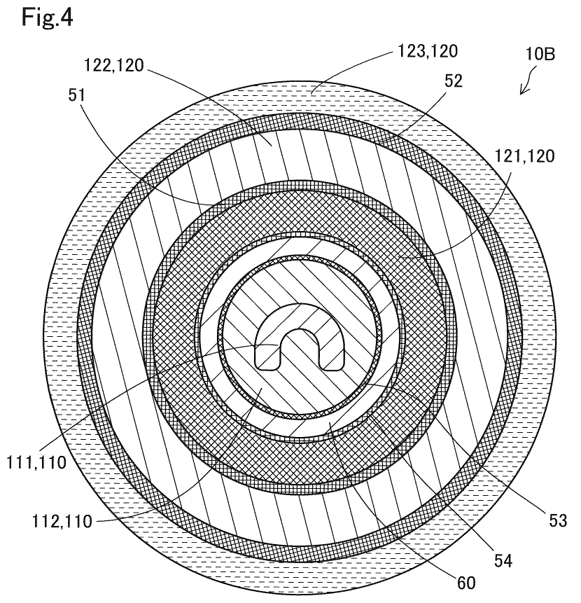

FIG. 4 shows a cross-sectional view of a gripping part 10B in the second embodiment. FIG. 4 corresponds to FIG. 2. The second embodiment differs from the first embodiment in that the gripping part 10B includes a heater layer 60.

The heater layer 60 is configured to raise the temperature of the gripping part 10B by generating heat by the conduction of electricity. The heater layer 60 is arranged between the core metal part 110 and the covering part 120. In the present embodiment, the heater layer 60 is attached on the surface of the core metal part 110 with a double-side tape 53. The heater layer 60 is attached further to the first layer 121 with a double-side tape 54. In the present embodiment, the heater layer 60 is formed by providing heat wire onto a non-woven fabric. The heat wire conducts electricity through electrical wire not illustrated. The conduction of electricity is controlled by the control unit 40.

The control unit 40 in the second embodiment switches on-/off-control of the conduction of electricity for the heater layer 60, on the basis of the gripping condition of the gripping part 10B. For example, when determining that the gripping part 10B is not gripped by a driver, the control unit 40 switches to off-control of the conduction of electricity for the heater layer 60. For example, when determining that the gripping part 10B has been gripped for a predetermined period of few seconds or longer, the control unit 40 switches to on-control of the conduction of electricity for the heater layer 60.

For example, in an embodiment in which the first layer 121 lacks conductivity, and in addition to the first layer 121, a material having conductivity is arranged between the covering part 120 and the core metal part 110, it is preferable for the material having conductivity to be in contact with the covering part 120, for the purpose of the detection of capacitance. Therefore, when the steering device 1 further includes the heater layer 60 configured to generate heat, the heater layer 60 is considered to be arranged between the material having conductivity and the core metal part 110 in many cases. In this case, the heat by the heater layer 60 may not be easily transferred to the covering part 120. In the steering device 1 in the second embodiment, since the heater layer 60 is arranged between the covering part 120 and the core metal part 110, the heat by the heater layer 60 is easily transferred to the covering part 120. The temperature of the gripping part 10B is increased effectively.

In the steering device 1 in the second embodiment, the first layer 121 is attached to the heater layer 60 with the double-side tape 54. As with the first embodiment, the second layer 122 is laminated on the first layer 121 with the double-side tape 51. This allows for the suppression of the exposure of the first layer 121 to air, compared to, for example, an embodiment in which the first layer 121 is simply layered on the heater layer 60, and accordingly allows for the suppression of the deterioration in accuracy of the first layer 121 as a detection electrode.

### C. Other Embodiments

### C1. Other Embodiment 1

(1) In the embodiments described above, the steering device 1 is mounted on a vehicle. A steering device may be mounted on a movable body other than a vehicle, for example, a ship or an aircraft.
(2) In the embodiments described above, the gripping part 10 has a substantially ring-like shape when viewed in the front-back direction. Alternatively, a gripping part may have, for example, a rectangular or trapezoidal shape when viewed in the front-back direction. Further alternatively, a gripping part may have, for example, a substantially rectangular-parallelepiped shape surrounding a rotation part.
(3) In the embodiments described above, the first layer 121 is made by applying metal plating on the surface of a textile fabric. Alternatively, a first layer may be formed of, for example, a fabric woven with metallic thread. Further alternatively, a first layer may be formed of, for example, metallic fiber such as steel wool, or a fabric woven with metallic thread and a textile fabric. A first layer in an embodiment made by applying metal plating on the surface of a textile fabric is excellent in elasticity, compared to a fabric woven with metallic thread.
(4) In the embodiments described above, synthetic fiber formed of polyester is used as the textile fabric. Alternatively, synthetic fiber formed of, for example, nylon, acryl, or polyurethane may be used as a textile fabric. Further alternatively, natural fiber, plant fiber, and animal fiber are selectable.
(5) For example, a first layer formed of a textile fabric subjected to metal plating, and a non-first layer formed of a textile fabric not subjected to metal plating are combined and arranged on the surface of a core metal part. A first layer subjected to metal plating may be arranged on a portion of a gripping part likely to be gripped by an occupant, and a non-first layer may be arranged on the other portion.
6. In the embodiments described above, the second layer 122 is formed of PET (Polyethylene terephthalate). A second layer may be formed of a rubber material, an elastomer material, or the like.
(7) In the embodiments described above, the control unit 40 executes airbag control, and notification control to a driver. For example, when a control unit determines that a gripping part has not been gripped for a predetermined period of time after notification, the control unit may transmit a signal for stopping a vehicle to an ECU.
(8) For example, a gripping part may include a shield layer and an insulating layer between a first layer and a core metal part. The shield layer is electrically connected to the first layer via a voltage follower circuit or the like, and is regulated to be at the same potential as the first layer. Accordingly, no electrical charge is stored in the first layer or the shield layer, and the first layer does not function as part of the capacitor configured with the first layer, the insulating layer, and the shield layer and the core metal part. As a result, it is possible to remove the noise caused by the potential difference generated between the first layer and a core metal, from the capacitance detected by a detector.

In an embodiment in which a gripping part includes an insulating layer and a shield layer, the insulating layer is a flexible substrate having insulation properties arranged between a first layer and the shield layer. As the insulating layer, a flexible thin film, for example, polyimide, or PET is used.

### C2. Other Embodiment 2

(1) In the embodiments described above, the first layer 121 is attached to the core metal part 110 with the double-side tape 50, and the second layer 122 is laminated on the first layer 121 with the double-side tape 51. Alternatively, a first layer may be fixed to a core metal part with adhesive, or a second layer may be fixed to a core metal part with adhesive. Adhesive mainly containing elastomer material, rubber material, or polyvinyl chloride may be used. Examples of the elastomer material include an acrylic-based type, a styrene-based type, a silicon-based type, an olefin-based type, and urethane-based type, and an epoxy-based type. Examples of the rubber material include butadiene rubber, silicone rubber, ethylene propylene diene rubber, and chloroprene rubber. The present embodiment also allows for the suppression of the exposure of the first layer to air, compared to, for example, an embodiment in which a first layer is sewn onto a core metal part, and accordingly allows for the suppression of the deterioration in accuracy.
(2) For example, a second layer may be attached on a first layer with a double-side tape or adhesive, and the first layer may be sewn onto a core metal part. Alternatively, a first layer may be attached to a core metal part with a double-side tape or adhesive, and a second layer may be fixed on the first layer with no use of a double-side tape or adhesive, so as to be laminated thereto. The present embodiment allows for the suppression of the deterioration in accuracy of the first layer as a detection electrode, compared to an embodiment in which a first layer is sewn onto a core metal part and a second layer is layered on the first layer.
(3) For example, a first layer may be fixed to a core metal part by welding or with pressure-sensitive adhesive. For example, a second layer may be fixed on a first layer by welding or with pressure-sensitive adhesive.

### C3. Other Embodiment 3

(1) In the second embodiment described above, the heater layer 60 has heat wire. For example, a heater layer may be formed of a flexible sheet material which includes a heating body in a resin material.
(2) In the second embodiment described above, the control unit 40 switches on-/off-control of the conduction of electricity for the heater layer 60, on the basis of the gripping condition of the gripping part 10. For example, a control unit may not control a heater layer on the basis of the gripping condition of a gripping part. For example, a control unit may continue on-control of the conduction of electricity for a heater layer during traveling of a vehicle, and turn to off-control of the conduction of electricity for the heater layer when vehicle's power is turned off.

### C4. Other Embodiment 4

(1) In the second embodiment described above, the first layer 121 is attached to the heater layer 60 with the double-side tape 54, and the second layer 122 is laminated on the first layer 121 with the double-side tape 51. For example, a first layer may be fixed to a heater layer with adhesive, and a second layer may be fixed to a core metal part with adhesive. Adhesive mainly containing elastomer material, rubber material, or polyvinyl chloride may be used. Examples of the elastomer material include an acrylic-based type, a styrene-based type, a silicon-based type, an olefin-based type, and urethane-based type, and an epoxy-based type. Examples of the rubber material include butadiene rubber, silicone rubber, ethylene propylene diene rubber, and chloroprene rubber. The present embodiment allows for the suppression of the exposure of the first layer to air, compared to, for example, an embodiment in which a first layer is simply layered on a heater layer, and accordingly allows for the suppression of the deterioration in accuracy of the first layer as a detection electrode.
(2) For example, a second layer may be fixed on a first layer with a double-side tape or adhesive, and the first layer may be fixed on a heater layer with no use of a double-side tape or adhesive. Alternatively, a first layer may be fixed to a core metal part with a double-side tape or adhesive, and a second layer may be fixed on the first layer with no use of a double-side tape or adhesive, so as to be laminated thereto. The present embodiment allows for the suppression of the deterioration in accuracy of the first layer as a detection electrode, compared to an embodiment in which a first layer is layered on a heater layer and a second layer is layered on the first layer.
(3) For example, a first layer may be fixed to a heater layer by welding or with pressure-sensitive adhesive. For example, a second layer may be fixed on a first layer by welding or with pressure-sensitive adhesive.

The present disclosure may be embodied in various configurations without departing from the spirit of the present disclosure, not limited to the above-described embodiments. For example, the technical features in the embodiments corresponding to the technical features in the respective aspects disclosed in the summary above may be appropriately replaced or combined in order to solve some or all of the above-described problems, or in order to achieve some or all of the above-described effects. Any of the technical features not described as essential in the present specification may be omitted appropriately. For example, this disclosure may be realized by the manner described below.

The present disclosure may be embodied in the following aspects.
(1) In one aspect of the present disclosure, a steering device is provided. The steering device is mounted on a movable body, and includes a rotation part attached to the movable body so as to be rotatable, and a gripping part connected to the rotation part and configured to be gripped by an occupant; the gripping part includes a core metal part positioned on both sides of the rotation part, and a covering part configured to cover the core metal part and including a first layer, a second layer, and a third layer; the first layer is positioned closer to the core metal part, compared to the second layer and the third layer, and has conductivity; the second layer is arranged between the first layer and the third layer, and is formed of a non-conductive material having flexibility; the third layer of the gripping part is exposed to outside, and is formed of a non-conductive material; and the steering device further includes a detector configured to detect a change in capacitance generated between the occupant gripping the gripping part and the first layer, and a control unit configured to determine gripping condition of the gripping part based on the change in capacitance detected by the detector.

In the steering device according to the aspect above, the first layer has conductivity, thus allowing for detection of the gripping condition of the gripping part on the basis of the change in capacitance of the first layer. The steering device is configured to ensure flexibility of the covering part and detect the gripping condition without being affected by the deterioration of the third layer, compared to, for example, an embodiment in which a conductive material is contained in the second layer formed of a material having flexibility and the third layer likely to be exposed to air because of the third layer configured to be gripped by the occupant.
(2) In the steering device according to the aspect above, the first layer may be fixed to the core metal part with a double-side tape or adhesive, and the second layer may be fixed on the first layer with a double-side tape or adhesive.

When the first layer having a conductive material is exposed to air, the accuracy of the detection of the first layer serving as a detection electrode may be lowered due to the low dielectric constant of air. In the steering device according to the aspect above, the first layer is fixed to the core metal part with a double-side tape or adhesive; and the second layer is fixed on the first layer with a double-side tape or adhesive. This allows for the suppression of the exposure of the first layer to air, compared to, for example, an embodiment in which the first layer is sewn onto the core metal part, and accordingly allows for the suppression of the deterioration in accuracy.
(3) In the steering device according to the aspect above, the steering device may further include a heater layer between the core metal part and the covering part, a heater layer may have heat wire, and the heat wire may be configured to conduct electricity.

For example, in an embodiment in which a first layer lacks conductivity, and in addition to the first layer, a material having conductivity is arranged between a covering part and a core metal part, it is preferable for the material having conductivity to be in contact with the covering part, for the purpose of the detection of capacitance. Therefore, when the steering device further includes the heater layer configured to generate heat, the heater layer is considered to be arranged between the material having conductivity and the core metal part in many cases. In this case, the heat by the heater layer may not be easily transferred to the covering part. In the steering device according to the aspect above, since the heater layer is arranged between the covering part and the core metal part, the heat by the heater layer is easily transferred to the covering part. The temperature of the gripping part is increased effectively.
(4) In the steering device according to the aspect above, the first layer may be fixed to the heater layer with a double-side tape or adhesive, and the second layer may be fixed on the first layer with a double-side tape or adhesive.

When the first layer having a conductive material is exposed to air, the accuracy of the detection of the first layer serving as a detection electrode may be lowered due to the low dielectric constant of air. In the steering device according to the aspect above, the first layer is fixed to the heater layer with a double-side tape or adhesive; and the second layer is fixed on the first layer with a double-side tape or adhesive. This allows for the suppression of the exposure of the first layer to air, compared to, for example, an embodiment in which the first layer is simply layered on the heater layer, and accordingly allows for the suppression of the deterioration in accuracy.

The present disclosure may be embodied in various aspects other than the steering device, for example, a gripping part, a vehicle equipped with a steering device, a method of producing a steering device, and a method of producing a gripping part.

What is claimed is:

1. A steering device mounted on a movable body, the steering device comprising:
a rotation part attached to the movable body so as to be rotatable; and
a gripping part connected to the rotation part, the gripping part configured to be gripped by an occupant,
the gripping part including:
a core metal part positioned on both sides of the rotation part; and
a covering part configured to cover the core metal part, the covering part including a first layer, a second layer, and a third layer,
the first layer positioned closer to the core metal part, compared to the second layer and the third layer, the first layer having conductivity,
the second layer arranged between the first layer and the third layer, the second layer formed of a non-conductive material having flexibility, the third layer of the gripping part exposed to outside, the third layer formed of a non-conductive material, and
the steering device further comprising:
a detector configured to detect a change in capacitance generated between the occupant gripping the gripping part and the first layer; and
a control unit configured to determine gripping condition of the gripping part based on the change in capacitance detected by the detector.

2. The steering device according to claim 1, wherein
the first layer is fixed to the core metal part with a double-side tape or adhesive, and
the second layer is fixed on the first layer with a double-side tape or adhesive.

3. The steering device according to claim 1, further comprising a heater layer between the core metal part and the covering part, the heater layer having heat wire, wherein
the heat wire is configured to conduct electricity.

4. The steering device according to claim 3, wherein
the first layer is fixed to the heater layer with a double-side tape or adhesive, and
the second layer is fixed on the first layer with a double-side tape or adhesive.
